(19) United States
(12) Patent Application Publication
(10) Pub. No.: US 2026/0289516 A1
(43) Pub. Date: Sep. 24, 2026

(54) SYSTEMS AND METHODS FOR AUGMENTED DISPLAYS

(71) Applicant: YAHOO ASSETS LLC, New York, NY (US)

(72) Inventors: Mohit GOENKA, Santa Clara, CA (US); Gnanavel SHANMUGAM, San Jose, CA (US); Nikita VARMA, Milpitas, CA (US); Ashish Khushal DHARAMSHI, Sunnyvale, CA (US)

(21) Appl. No.: 19/084,978

(22) Filed: Mar. 20, 2025

(51) Int. Cl. G06Q 10/1093; G06V 30/42

(52) U.S. Cl. CPC G06Q 10/1093; G06F 16/1748; G06V 10/10; G06V 30/42

(57) ABSTRACT

Disclosed are systems and methods that provide a scalable, decision intelligence (DI)-based computerized framework for bidirectional synchronization between physical and digital calendars. The disclosed framework can bridge the persistent gap between traditional analog calendars and modern digital scheduling systems. The technology can enable synchronized calendar information across multiple formats simultaneously. The framework can leverage computer vision to digitize handwritten calendar entries, process unstructured notations into standardized calendar data, and render digital calendar information as augmented reality overlays on physical calendars. By creating a continuous two-way flow of calendar data, the disclosed framework can eliminate information disparities, such that a hybrid approach can be utilized that combines the tactile accessibility and visibility of physical calendars with the integration capabilities, sharing features, and notification systems of digital calendars into a unified scheduling ecosystem.

### FIELD OF THE DISCLOSURE

The present disclosure relates to electronic management and control of digital content, and more particularly, to a decision intelligence (DI)-based computerized framework for formatting, modifying, converting, or otherwise digitizing and synchronizing information within a set of data structures for access and control over a network across a set of devices and/or network locations.

### SUMMARY OF THE DISCLOSURE

According to some embodiments, the disclosed systems and methods provide a framework for bidirectional physical-to-digital calendar synchronization. As discussed herein, in some embodiments, the disclosed technical framework for bidirectional synchronization between physical and digital calendars can enable seamless integration of traditional paper calendars with modern digital calendar systems through artificial intelligence and/or machine learning technologies (AI/ML—e.g., computer vision, natural language processing (NLP), and the like, discuss infra), as well as, but not limited to, augmented reality (AR), virtual reality (VR) and/or extended reality (XR) technologies, and the like. By bridging the gap between analog and digital calendar systems, the disclosed framework can address synchronization challenges within and/or across locations (e.g., households) where multiple calendar formats coexist.

Despite the prevalence of digital calendars, physical calendars remain common in many households and workplaces. The persistence of these analog systems alongside digital equivalents often results in information disparity and synchronization problems. The disclosed framework can function and/or operate to address such technical challenges, among others, through a technological solution that enables bidirectional data flow between physical and digital calendar representations.

According to some embodiments, the disclosed framework can operate through several key components working in concert, as discussed herein and in more detail below. According to some embodiments, the framework can utilize various forms of image data/metadata, which can be tied to and/or captured via camera sources for capturing physical calendar data, including dedicated cameras positioned to continuously monitor the calendar, smart home devices with camera capabilities, mobile device cameras for on-demand synchronization, AR glasses cameras for real-time interpretation, and the like. Such image acquisition mechanisms can function opportunistically (e.g., continuously and/or periodically) by updating the digital representation whenever new physical calendar data becomes visible to any available camera system. Thus, once calendar images become available, the framework's processing pipeline can, for example, detect and isolate the calendar region within the image field, recognize the calendar's structural format including daily, weekly, or monthly layouts, identify written entries using optical character recognition, process handwritten text through specialized recognition algorithms, and extract spatial and temporal data to determine event placement.

According to some embodiments, the extracted text can undergo processing through, for example, NLP mechanisms, which can perform entity recognition to identify, for example, event names, locations, and participants, temporal reference resolution to determine precise timing information, context-aware interpretation of informal time references, and structuring of unformatted calendar notes into standardized event objects. The NLP operations can transform casual notations such as “dinner with Bob at 8 pm” into structured calendar entries with appropriate metadata fields for digital calendar integration. In some embodiments, the framework can interface with multiple digital calendar platforms through application program interface (API) integration with major calendar providers including, for example, Yahoo!®, Google®, Apple®, Microsoft®, and the like. In some embodiments, as discussed herein, the framework can perform standardized calendar data format conversion supporting, for example, CalDAV (or iCal (ICS)) protocols, implement event deduplication and conflict resolution mechanisms, and maintain synchronization verification and error correction protocols. Such mechanisms implemented by the framework can maintain consistent event representation across platforms while preserving the unique features of each calendar system.

According to some embodiments, for displaying digital calendar information atop physical calendars, the framework can provide AR visualization mechanisms that can register the physical calendar's position in three-dimensional (3D) space, map digital calendar entries to corresponding positions on the physical calendar, render digital event information through AR-capable devices, provide interactive capabilities for editing and managing events, and visually distinguish between physical-only, digital-only, and synchronized events, and the like. Such visualization can function across multiple AR platforms including, but not limited to, smartphones, tablets, AR glasses, AR-equipped smart home displays, and the like.

Accordingly, in some embodiments, the framework can generate printable calendar representations that merge physical and digital data, format output for compatibility with standard printer systems, optimize layout to maintain visual consistency with existing physical calendars, and schedule automatic printing when significant digital updates occur.

In some embodiments, as to privacy and security, the framework can process calendar information locally on the user's devices through edge computing algorithms for image recognition and NLP. In some embodiments, the framework can implement secure local storage of calendar images and extracted data, device-based authentication for accessing synchronized calendar information, and optional encrypted cloud backup for multi-device synchronization. The framework's recognition functionality, via AI/ML models, can improve through personalized handwriting recognition models that adapt to household members, pattern recognition for recurring events and habits, context-aware event categorization based on user history, and continuous improvement through feedback loops when corrections occur.

In some embodiments, data processing can occur primarily on local devices to minimize privacy concerns. As discussed in more detail below, in some embodiments, the framework can implement differential privacy techniques when cloud features become necessary, ensuring that sensitive calendar information remains protected. Calendar data can be encrypted both in transit and at rest, with access controls that respect household privacy boundaries. The applied and/or implemented synchronization protocol can handle edge cases such as partially visible entries, crossed-out items, and ambiguous notations through confidence scoring and optional user verification for low-confidence interpretations.

In some embodiments, the framework's bidirectional synchronization can operate through change detection in both physical and digital calendars, timestamp-based conflict resolution, merge operations for complementary information, user-confirmable updates for ambiguous cases, historical version tracking for manual reconciliation when needed, and the like. Thus, as evidenced from the discussion herein, users can benefit from reduced time spent manually transferring information between calendar systems, decreased likelihood of missed events due to synchronization failures, improved family coordination through consistent calendar information, and integration with smart home systems for event-based automation.

In some embodiments, the framework can improve calendar accessibility through voice interface integration for auditory access to physical calendar information, standardized digital format compatibility with screen readers and other assistive technologies, and enlarged or high-contrast AR visualization options.

The framework is configured to support various physical calendar formats beyond traditional wall calendars, including desk planners, academic calendars, and custom layouts. The digital representation can preserve visual cues from the physical calendar while enhancing them with additional metadata and integration capabilities. The printing component can optimize ink usage and layout for frequent updates while maintaining readability and aesthetic consistency with the original physical calendar. For locations with multiple physical calendars in different locations, the framework can maintain consistency across all representations, resolving conflicts according to user-defined priority rules.

Accordingly, the disclosed framework can function to bridge the gap between physical and digital calendar paradigms, where, through bidirectional synchronization, the framework can address persistent challenges in household and workplace organization. Such modular architecture allows for flexible implementation across various devices and platforms, while local processing preserves privacy and security.

According to some embodiments, a method is disclosed for a DI-based computerized framework for formatting, modifying, converting, or otherwise digitizing and synchronizing information within a set of data structures for access and control over a network across a set of devices and/or network locations. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for formatting, modifying, converting, or otherwise digitizing and synchronizing information within a set of data structures for access and control over a network across a set of devices and/or network locations.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

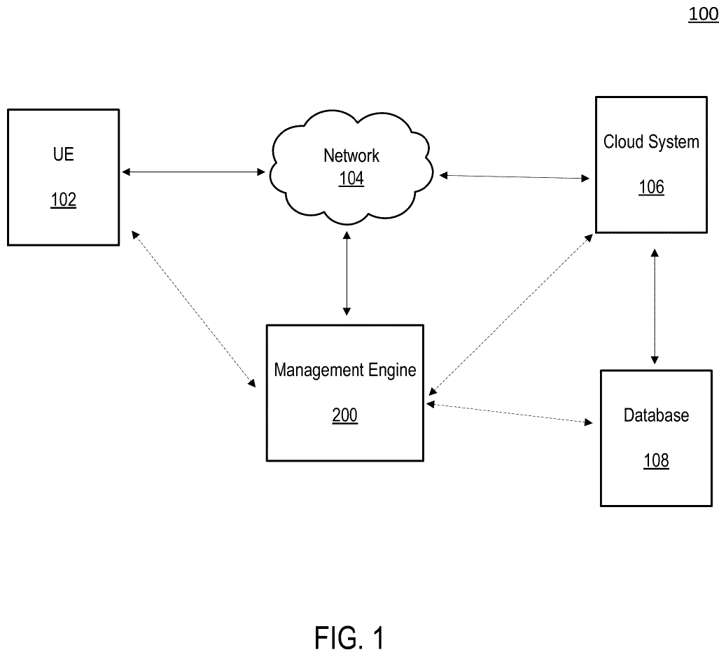

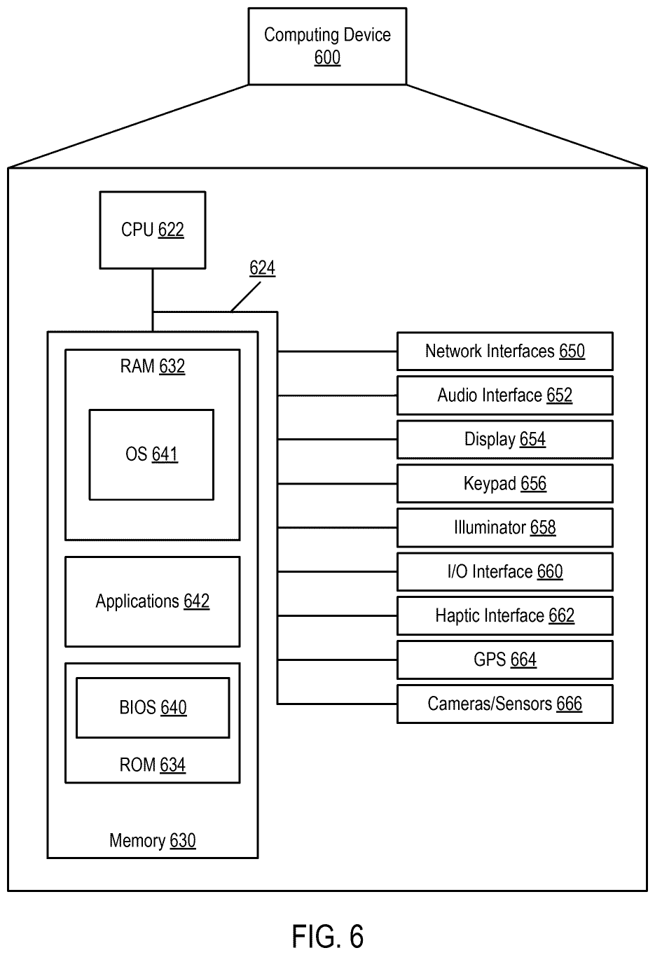

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic mail platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

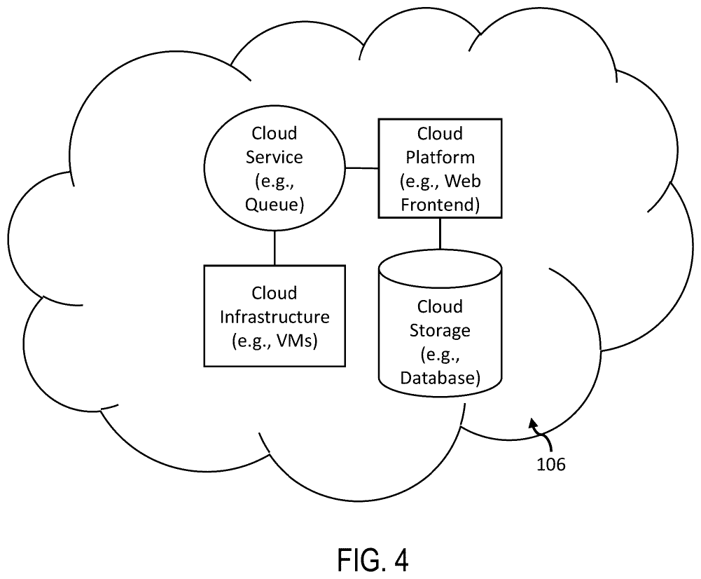

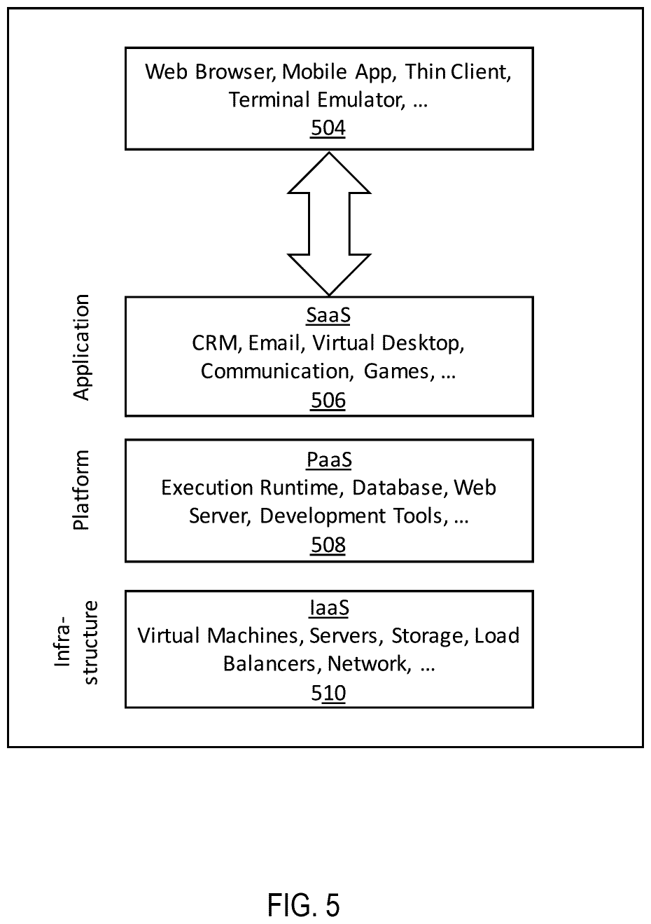

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

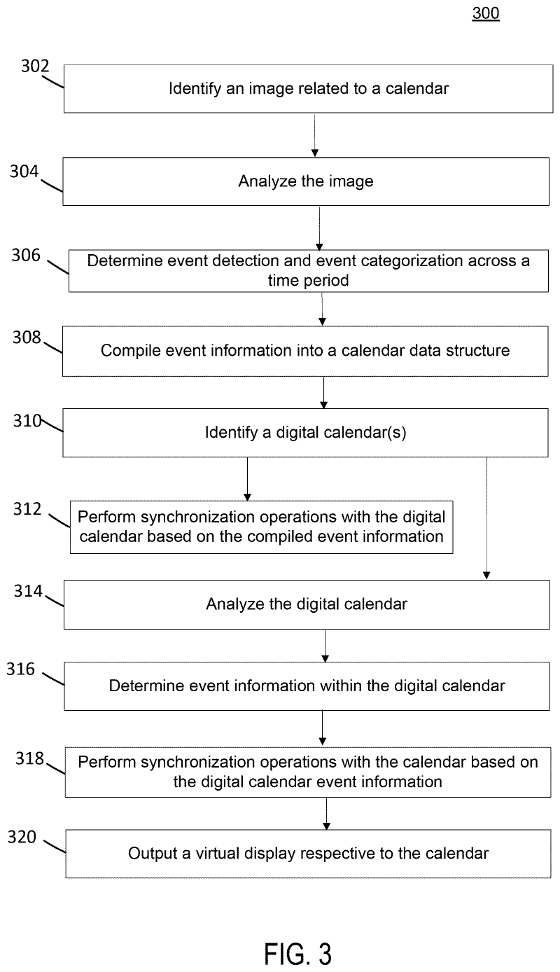

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

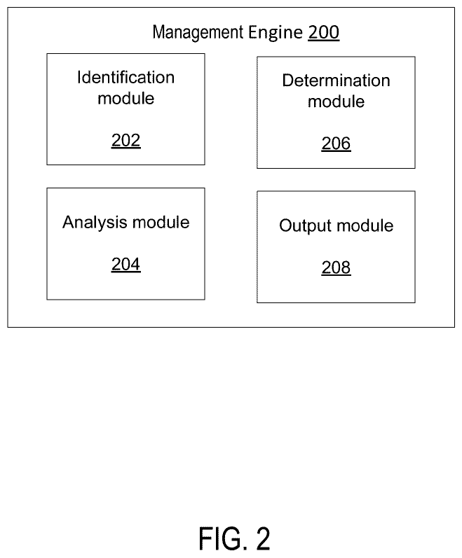

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

According to some embodiments, management engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for a DI-based computerized framework for formatting, modifying, converting, or otherwise digitizing and synchronizing information within a set of data structures for access and control over a network across a set of devices and/or network locations. As discussed herein, the disclosed framework can create continuous electronic two-way flow of calendar data that enables the elimination of information disparities without forcing users to abandon familiar physical calendars. The disclosed hybrid approach can combine the tactile accessibility and visibility of physical calendars with the integration capabilities, sharing features, and notification systems of digital calendars into a unified scheduling ecosystem.

According to some embodiments, Steps 302 and 310 of Process 300 can be performed by identification module 202 of management engine 200; Steps 304 and 314 can be performed by analysis module 204; Steps 306 and 316 can be performed by determination module 206; and Steps 308, 312, 318 and 320 can be performed by output module 208.

According to some embodiments, Process 300 begins with Step 302 where engine 200 can identify an image related to a calendar, which in some embodiments, can be performed via engine 200 acquiring a digital image of a physical calendar. Such image can be captured via various sources, including, but not limited to, a smartphone camera, a dedicated camera positioned to monitor a calendar in real-time, a network-based storage system retrieving previously saved images, and the like. In some embodiments, engine 200 can retrieve calendar images from cloud-based storage and/or smart home devices with image acquisition capabilities.

In Step 304, engine 200 can analyze the captured image to achieve contextual understanding and intelligent event interpretation. In some embodiments, such computational analysis can involve engine 200 calling and executing an AI and/or ML model and/or a large language model (LLM). Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

Accordingly, in some embodiments, such analysis can involve preprocessing operations such as, but not limited to, noise reduction, perspective correction, and image segmentation to extract relevant calendar regions. Optical character recognition (OCR) can be applied to extract textual information, identifying event titles, dates, times, and annotations. Additionally, layout analysis can be performed to determine the structural format of the calendar, such as distinguishing between daily, weekly, or monthly views.

In some embodiments, engine 200 can employ contextual understanding beyond traditional OCR, recognizing grid structures, font variations, and visual cues like color coding to enhance interpretation accuracy. In some embodiments, handwritten text recognition algorithms can be employed to interpret manually written entries, leveraging machine learning models trained on diverse handwriting styles. Furthermore, engine 200 can handle complex handwritten annotations, including crossed-out entries, insertions, and other handwritten modifications that might confuse standard OCR systems.

In Step 306, engine 200 can determine event detection (occurrence) and categorization across a time period by associating recognized text with corresponding calendar dates. In some embodiments, such determination can be performed via spatial analysis, where engine 200 maps text elements to predefined date positions based on the detected layout structure. In some embodiments, engine 200 can execute NLP mechanisms to refine event interpretation by recognizing entities such as, but not limited to, event names, locations, participants, temporal references, and the like.

In some embodiments, NLP operations performed by engine 200 can process unstructured text and detect recurring patterns, such as events that happen every week or month, even if they are not explicitly labeled as recurring. For example, “Yoga Class” written repeatedly on different Tuesdays can be detected as a recurring event. Engine 200, in some embodiments, can apply contextual event recognition determinations, thereby distinguishing between work-related meetings, social events, personal reminders, and other categories based on linguistic cues and user-defined patterns. Additionally, engine 200 can analyze visual elements, such as color-coded markings or underlined text, to infer priority levels or categorize events more accurately.

In Step 308, engine 200 can compile extracted event information into a structured calendar data structure (or data model). Such data structure creation/generation can involve normalizing data formats, assigning metadata attributes (e.g., event priority, reminders, and category tags), and resolving ambiguities through confidence scoring. In some embodiments, engine 200 can function to ensure and/or validate that recurring events are correctly identified and structured into digital formats, reducing redundant manual inputs. Accordingly, the data structure can be configured for integration with digital calendar platforms (e.g., convert format, data/metadata, and/or other digital information for integration into a CalDAV format and/or API for a calendar application or mail application, for example).

In Step 310, engine 200 can identify digital calendars associated with a user, utilizing authentication mechanisms to access linked accounts. In some embodiments, such identification can involve querying user profiles from various calendar service providers (e.g., Yahoo Calendar, for example) via an associated API.

According to some embodiments, when multiple digital calendars are detected, the system can prioritize synchronization based on user-defined preferences and/or historical usage patterns. While the discussion herein may focus on a single digital calendar, it should therefore not be construed to be limiting, as the synchronization and/or bi-directional synchronization discussed herein can be performed for a plurality of calendars, inclusive of physical and digital calendars, without departing from the scope of the instant disclosure.

In Step 312, engine 200 can perform synchronization operations with the digital calendar based on the compiled event information. Such synchronization can involve merging the first calendar with a second calendar, whereby the determined occurrence and categorization for each event in the first calendar can be input into the second calendar, thereby modifying the second calendar to include the event information for the time period from the first calendar.

In some embodiments, such synchronization can involve checking for duplicate events, resolving potential conflicts, and ensuring compatibility with the target calendar format (e.g., CalDAV, iCal). In some embodiments, engine 200 can implement event deduplication by comparing extracted events with existing digital entries using similarity-matching algorithms. Additionally, synchronization can include updating event details, modifying recurring event structures, and handling event deletions when necessary. In some embodiments, engine 200 can apply intelligent conflict resolution mechanisms by automatically merging complementary event details and alerting users when discrepancies require further analysis and/or manual intervention.

In Step 314, engine 200 can analyze the digital calendar to extract existing event information. In some embodiments, such analysis can be performed in a similar manner discussed in relation to Steps 304-306, discussed supra. In some embodiments, such analysis can involve retrieving calendar data through API queries and performing temporal analysis to assess event distributions, overlapping schedules, and availability slots. In some embodiments, contextual event enrichment can be performed, where NLP models analyze event descriptions to infer additional attributes such as meeting agendas, participant roles, or location-based contextualization. In some embodiments, engine 200 can function, via the AI/ML processing discussed above, to detect gaps and/or inconsistencies between physical and digital calendars, and recommend updates where necessary.

In Step 316, engine 200 can determine event information within the digital calendar by categorizing events into structured segments. In some embodiments, such determination can involve identifying work-related meetings, social gatherings, personal tasks, and reminders. In some embodiments, engine 200 can leverage AI/ML-driven classification models to enhance event segmentation, improving user experience by providing categorized views of calendar data. The categorization process can integrate semantic understanding, differentiating between different event types even if they share similar text patterns. For example, “Lunch with Bob” on a work calendar can be classified as a business meeting, while the same phrase on a personal calendar can be categorized as a social event.

In Step 318, engine 200 can perform bidirectional synchronization by updating the physical calendar representation based on digital calendar modifications. In some embodiments, for example, such synchronization can be accomplished using AR overlays, where AR-capable devices project digital event updates onto a real-world physical calendar. In some embodiments, engine 200 can function to ensures alignment between physical and digital event states, resolving inconsistencies through automated change detection and user verification mechanisms. Thus, for example, if an event is deleted or modified in the digital calendar, engine 200 ensures that these changes are accurately reflected in the AR-enhanced visualization.

And, in Step 320, engine 200 can output a virtual display over the calendar (physical calendar from Step 302) based on a request. In some embodiments, for example, such output can include, but is not limited to, rendering AR-based visualizations through smartphones, AR glasses, smart home displays, and the like, thereby providing an interactive experience of viewing and managing synchronized events. In some embodiments, such output can involve engine 200 modifying the display to distinguish between physical-only, digital-only, and synchronized events using color-coded indicators, font indicators/modifications, animations, overlay annotations, and the like, or some combination thereof. In some embodiments, gesture-based controls allow users to interact with the AR display to edit, delete, or confirm event changes. Thus, such an AR overlay can also enhance accessibility by providing voice-based interaction for users who prefer auditory event management.

Accordingly, the framework implemented by engine 200 via the steps of Process 300, discussed supra, provides a robust technical solution for seamless bidirectional synchronization between physical and digital calendars. By leveraging AI/ML-driven image processing, NLP-based event interpretation, and API-based calendar integration, engine 200 ensures accuracy, efficiency, and real-time synchronization. Moreover, privacy and security measures, including local data processing and encrypted storage, safeguard user information while maintaining accessibility across multiple devices and platforms. The bidirectional analysis performed by engine 200 enables adaptive learning, allowing the system to refine recognition accuracy and enhance user experience through continuous improvement mechanisms.

FIG. 6 is a schematic diagram illustrating a client device showing an example embodiment of a client device that can be used within the present disclosure. Client device 600 can include many more or less components than those shown in FIG. 6. However, the components shown are sufficient to disclose an illustrative embodiment for implementing the present disclosure. Client device 600 can represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 can optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 can be a liquid crystal display (LCD), gas plasma, light emitting diode (LED), or any other type of display used with a computing device. Display 654 can also include a touch sensitive screen arranged to receive input from an object such as a stylus or a digit from a human hand.

Keypad 656 can include any input device arranged to receive input from a user. Illuminator 658 can provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 can through other components, provide other information that can be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores can be employed to store information that describes various capabilities of Client device 600. The information can then be provided to another device based on any of a variety of events, including being sent as part of a header (e.g., index file of the HLS stream) during a communication, sent upon request, or the like. At least a portion of the capability information can also be stored on a disk drive or other storage medium (not shown) within Client device 600.

Applications 642 can include computer executable instructions which, when executed by Client device 600, transmit, receive, and/or otherwise process audio, video, images, and enable telecommunication with a server and/or another user of another client device. Applications 642 can further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors can be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors can be dual-core processor(s), dual-core mobile processor(s), and so forth.

Computer-related systems, computer systems, and systems, as used herein, include any combination of hardware and software. Examples of software can include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements can vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

One or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure can be downloadable from a network, for example, a website, as a stand-alone product or as an add-in package for installation in an existing software application. For example, exemplary software specifically programmed in accordance with one or more principles of the present disclosure can also be available as a client-server software application, or as a web-enabled software application. For example, exemplary software specifically programmed in accordance with one or more principles of the present disclosure can also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

What is claimed is:

1. A method comprising:
capturing an image of a first calendar, the first calendar being a physical calendar, the first calendar comprising event information for a time period;
analyzing the image of the first calendar, and extracting the event information;
determining, based on the extracted event information, an occurrence and categorization for each event indicated within the image of the first calendar within the time period; and
synchronizing the first calendar with a second calendar, the second calendar being a digital calendar, the synchronization being performed based on the determined occurrence and categorization for the first calendar, the synchronization comprising modifying the second calendar to include the event information for the time period from the first calendar.

2. The method of claim 1, further comprising:
analyzing the second calendar, and determining event information included within the second calendar for the time period; and
synchronizing the second calendar with the first calendar based on the event information within the second calendar and the event information within the first calendar.

3. The method of claim 2, further comprising:
generating a visual display based on the synchronization of the second calendar with the first calendar; and
providing, for display via a device, the visual display causing a display of the event information of the second calendar to be virtually displayed along with the event information for the first calendar.

4. The method of claim 3, further comprising the visual display being one of a augmented reality (AR) display, virtual reality (VR) display or extended reality (XR) display.

5. The method of claim 1, further comprising the synchronization comprising de-duplication for information related to events within the first calendar and the second calendar.

6. The method of claim 1, further comprising the second calendar being associated with an account of a user, the first calendar being a calendar of the user.

7. The method of claim 1, further comprising retrieving the image of the first calendar from a data store.

8. A method comprising:
capturing an image of a first calendar, the first calendar being a physical calendar, the first calendar comprising event information for a time period;
synchronizing the event information of the first calendar with event information of a second calendar for the time period, the second calendar being a digital calendar;
generating a visual display based on the synchronization; and
providing, for display via a device, the visual display causing a display of the event information of the second calendar to be virtually displayed along with the event information for the first calendar.

9. The method of claim 8, further comprising the visual display being one of a augmented reality (AR) display, virtual reality (VR) display or extended reality (XR) display.

10. The method of claim 8, further comprising:
analyzing the image of the first calendar, and extracting the event information;
determining, based on the extracted event information, an occurrence and categorization for each event indicated within the image of the first calendar within the time period; and
synchronizing the first calendar with the second calendar, the synchronization being performed based on the determined occurrence and categorization for the first calendar.

11. The method of claim 10, further comprising the synchronization comprising modifying the second calendar to include the event information for the time period from the first calendar.

12. A device comprising;
a processor configured to:
capture an image of a first calendar, the first calendar being a physical calendar, the first calendar comprising event information for a time period;
analyze the image of the first calendar, and extract the event information;
determine, based on the extracted event information, an occurrence and categorization for each event indicated within the image of the first calendar within the time period; and
synchronize the first calendar with a second calendar, the second calendar being a digital calendar, the synchronization being performed based on the determined occurrence and categorization for the first calendar, the synchronization comprising modifying the second calendar to include the event information for the time period from the first calendar.

13. The device of claim 12, wherein the processor is further configured to:
analyze the second calendar, and determining event information included within the second calendar for the time period; and
synchronize the second calendar with the first calendar based on the event information within the second calendar and the event information within the first calendar.

14. The device of claim 13, wherein the processor is further configured to:
generate a visual display based on the synchronization of the second calendar with the first calendar; and
provide, for display via the device, the visual display causing a display of the event information of the second calendar to be virtually displayed along with the event information for the first calendar.

15. The device of claim 14, wherein the processor is further configured such that the visual display is one of a augmented reality (AR) display, virtual reality (VR) display or extended reality (XR) display.

16. The device of claim 12, wherein the processor is further configured such that synchronization comprises de-duplication for information related to events within the first calendar and the second calendar.

17. The device of claim 12, wherein the processor is further configured such that the second calendar is associated with an account of a user, the first calendar being a calendar of the user.

18. The device of claim 12, wherein the processor is further configured to retrieve the image of the first calendar from a data store.

19. The device of claim 12, further comprising the device being a user device.

20. The device of claim 12, further comprising the device being a cloud device.
